(19) United States
(12) Patent Application Publication
(10) Pub. No.: US 2013/0008990 A1
(43) Pub. Date: Jan. 10, 2013

(54) MATERIAL GRINDING DEVICE

(75) Inventor: Chuguevsky Andrei Yurievich, Moskovskaya obl. (RU)

(73) Assignee: ARTER TECHNOLOGY LIMITED, Guernsey (RU)

(21) Appl. No.: 13/142,216

(22) PCT Filed: Dec. 7, 2009
(86) PCT No.: PCT/RU09/00672

§ 371 Date: Sep. 19, 2011

(30) Foreign Application Priority Data
Dec. 25, 2008 (RU) 2008151412

(51) Int. Cl. B02C 7/02

(52) U.S. Cl. 241/251

(57) ABSTRACT

The essence of the invention is that the material grinding device comprises a housing with a unit for feeding the material to be ground and a unit for removing the finished product. An annular grinding chamber and two rotors are accommodated in the housing. The rotors are coaxially arranged and can rotate. Blades for accelerating the material to be ground and feeding sad material into the grinding chamber are mounted on one of the rotors. Blades for supplying air into the grinding chamber are mounted on the other rotor. The device is provided with at least one distributor. Said distributor is designed in the form of blades which are secured on the housing and disposed in the grinding chamber. The vanes of the distributor are equally spaced along a circle, the center of which is situated on the longitudinal axis of symmetry of the rotors.

The invention is applied to machines for grinding of mineral and phytogenous materials and may be used in building, mining, chemical, power and other industries.

There is a grinding machine which consists of a frame with the appliance for grinding material supply and with the applicance for removal of ready-made product, also a grinding chamber and two rotatable rotors encased in a frame in alignment with fracturing elements (for example, see Patent No. 2166367 of the Russian Federation, clas. B02C 7/08, published on Oct. 5, 2001).

With the help of the given machine the material is grinded in several consecutive stages, and at each stage the particles are fractured under the certain mechanism. Among the disadvantages of the given machine are relatively high energy consumption and high structural complexity.

The closest technical prototype, with the similar technical result achieved, can be referred to the machine for material grinding which consists of a frame with the appliances for grinding material supply and removal of the ready-made product respectively, an annular grinding chamber, two rotatable rotors fixed on a frame in alignment, with blades for acceleration of the grinding material and its supply to a grinding chamber fixed on one rotor, and the blades for air delivery to a grinding chamber fixed on the second rotor (see Patent No. 2193448 of the Russian Federation, clas. B02C 19/06, published on 27 Nov. 2002).

The given machine partially remedies the deficiencies of the above-described analog at the expense of more simple design and relatively low energy consumption during the grinding process. Relatively low efficiency of the grinding process due to high percentage of partially unmilled particles in the final product can be referred to disadvantages of this machine. The circumstance mentioned above is resulted from the fact that the probability of collision of the particles of the material being grinded in a chamber is not high enough. The grinding particles get into the grinding chamber along the curvilinear trajectory and unevenly around the periphery of the grinding chamber. The oncoming air flow enters the chamber along the curvilinear trajectory as well, and that considerably reduces the probability of the repeated collision of the partially grinded particles in the grinding chamber. As a result of given effect there are unmilled particles occuring in the ready-made product, what reduces homogeneity of the latter and in turn requires the re-grinding process.

The invention is intended to perform the task of designing such a machine for material grinding that would provide increase of fine grinding efficiency by reducing quantity of the unmilled particles in final product. The technical result that may be achieved by implementing the invention consists in increased homogeneity of the ready-made product at the expense of increased probability of collision of the particles of the grinded material in a grinding chamber.

The task set forth was resolved due to the fact that the machine for grinding which includes a frame with the appliances for supply of the grinding material and removal of the ready-made product respectively, an annular grinding chamber, two rotating rotors fixed on a frame and placed inside a frame cavity in alignment with the blades for acceleration of grinding material and sending it to a grinding chamber fixed on one rotor and blades for air delivery to a grinding chamber fixed on the second rotor, is equipped with at least one guiding vane. At that this guiding vane is performed in the form of vanes fixed on a frame and placed inside the grinding chamber evenly in a circle, and the center of this circle lies on longitudinal symmetry axis of the rotors.

Besides that, the task set for the was resolved by placing the guiding vane both at the exit of the blades for acceleration of material and its supply to the grinding chamber and at the exit of blades for air supply to the grinding chamber.

The gist of invention is explained in drawings where

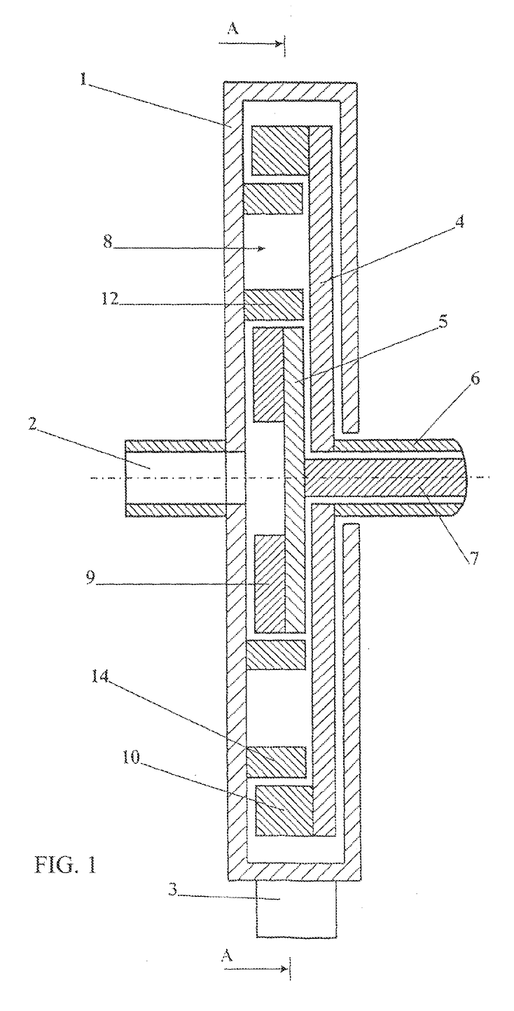

FIG. 1 represents sectional drawing of the grinding machine and

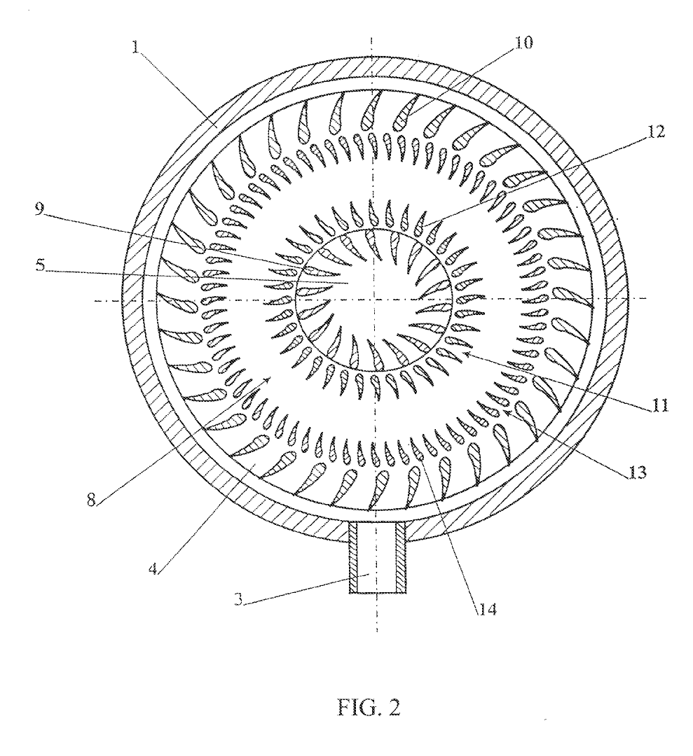

FIG. 2 sectional drawing of A-A at FIG. 1.

The machine for material grinding consists of a Frame 1 with Appliance 2 for the supply of grinding material (layout view in drawings) and Appliance 3 for removal of the ready-made product (shown in the drawings schematically). Appliance 2 for supply of the grinding material to Frame 1 of the machine may be performed, for example, in the form of a screw feeder (in case of vertical configuration of Frame 1) of any known design that executes compulsory and dosed feed of grinding material into the cavity of Frame 1, or in the form of funnel (in case of horizontal configuration of Frame 1), through which the grinding material goes in the cavity of Frame 1 by dozes under gravitation force. Appliance 3 for the removal of the ready-made product from the cavity of Frame 1 may be executed in the form of branch pipe (in case of vertical positioning of Frame 1), through which the ready-made product is removed from the frame under the action of the gravitation force, or in the form of air pump (in case of horizontal positioning of Frame 1), which executes compulsory removal of the ready-made product from Frame 1. There are two rotors (Rotor 4 and Rotor 5) coaxially installed in the cavity of Frame 1. These rotors may revolve inside Frame 1. Rotor 4 is kinematically connected to an engine (not shown in the drawings) by means of shaft 6. Rotor 5 is kinematically connected to an engine (is not shown in the drawings) by means of shaft 7. The torque may be transmitted to Shafts 6 and 7 as from the general engine, so from the individual engine. The electrical motor may be used in the capacity of an engine. An annular grinding chamber is placed inside the cavity of Frame 1. Blades 9 for acceleration of the grinding material and its supply to the Grinding chamber 8 are fixed on Rotor 5. Blades 9 may have streamlined configuration, for example, wing-shaped or plate-shaped (not shown in the drawings) and are connected to Rotor 5 with the help of plug-type connection or permanent joint. Blades 9 are evenly arranged around the circle, the center of which is on longitudinal symmetry axis of Rotor 5. Blades 10 are fixed on Rotor 4 to supply the air into the Grinding Chamber 8. Blades 10 may have streamlined configuration, for example, wing- or plate-shaped, and are connected to Rotor 4 with the help of plug-type connection or permanent joint. Blades 10 are evenly arranged around the circle, the center of which is on the longitudinal symmetry axis of Rotor 4. There is at least one Guiding Device 11 in the cavity of Frame 1. The Guiding Device 11 is made in the form of Vanes 12 fixed on Frame 1 with the help of plug-type connection or permanent joint. Vanes 12 of the Guiding Device 11 are placed in the grinding Chamber 8 evenly around circle, the center of which lies on the longitudinal symmetry axis of Rotors 4 and 5, i.e. the Vanes 12 of the Guiding Device 11, Blades 9 for acceleration of the grinding material and its supply to the Grinding Chamber 8 and Blades 10 for air delivery to the Grinding Chamber 8 are installed coaxially. It should be noted that such constructive embodiment of the grinding machine design is preferred here, where the pitch of Vanes 12 of the Guiding Device 11 varies (preferably should be lesser) from the pitch of Blades 9 for acceleration of the grinding material and its supply to the Grinding Chamber 8. The machine can be executed with additional Guiding Device 13 made in the form of Vanes 14, fixed on Frame 1 and encased in Grinding Chamber 8. Vanes 14 of additional Guiding Device 13 are evenly placed around the circle, the center of which lies on the longitudinal symmetry axis of Rotors 4 and 5. When assembling the machine, it is recommended that the pitch of Vanes 14 of additional Guiding Device 13 varies from the pitch of Blades 10 for air delivery to Grinding Chamber 8 and preferably is lesser. It should be noted that the cross-section of each exit channel formed by adjacent Vanes 12 of Guiding Device 11 and adjacent Vanes 14 of additional Guiding Device 13 is relatively radial-oriented towards the annular Grinding Chamber 8.

In one of the options of constructive machine execution the disposition of the guiding device at the outlet of Blades 9 for acceleration of the grinding material and its supply to the Grinding Chamber 8 is possible. Guiding Device 11 (FIG. 2) illustrates an example of such option.

Another option allows to place the guiding device at the outlet of Blades 10 for air delivery to Grinding Chamber 8. Guiding Device 13 (FIG. 2) illustrates an example of such option.

The machine for material grinding is running in the following way.

Rotary drives of Shafts 6 and 7 that transmit rotating moment to Rotors 4 and 5 should be switched on. Simultaneously the preliminary prepared grinding material should be supplied to the cavity of Frame 1 with the help of Appliance 2 for supply of grinding material. Grinding material enters the cavity of Frame 1 in certain dozes and is taken by Blades 9 for acceleration of the grinding material and its supply to Grinding Chamber 8. Having trapped the grinding material Blades 9 for acceleration of the grinding material and its supply to Grinding Chamber 8 form the streams of suspended solid material consisting of a mixture of grinding material and air entrapped by Blades 9 (for acceleration of grinding material and its supply to Grinding Chamber 8). Before entering Grinding Chamber 8 the streams of suspended solid material get onto Vanes 12 of Guiding Device 11. When passing through Vanes 12 of Guiding Device 11, first of all, the material contained in suspension is partially grinded because of collision with the butt ends of Vanes 12 of Guiding Device 11. Secondly, Vanes 12 of Guiding Device 11 split the streams of suspension, and that provides more even inflow of the grinding material along the perimeter of Grinding Chamber 8. Thirdly, Vanes 12 of Guiding Device 11 change the direction of the streams to flow into Grinding Chamber 8 thus ensuring the radial inlet of the grinding material into Grinding Chamber 8. Simultaneously Blades 10 for air delivery into Grinding Chamber 8 rotating together with Rotor 4 in rotary mode initiate the air flow to enter the Grinding Chamber 8 towards suspension streams. Here the particles of the grinded material contained in suspension streams get into effective zone of the air flow created by Blades 10 for air delivery into Grinding Chamber 8, and change the direction of their motion into opposite. The particles having changed the direction of motion into the opposite start colliding with the particles of grinded material contained in suspension streams moving towards them with the higher speed. And as a result they are mutually destructed. The process of particles movement in Grinding Chamber 8 is repeated manifold until the material becomes almost homogenous in size. In case of placement of additional Guiding Device 13 at the outlet of Blades 10 for air delivery into Grinding Chamber 8 the process of material grinding does not differ from the described above. The air flow created by Blades 10 for air delivery into Grinding Chamber 8 passes through Vanes 14 of additional Guiding Device 13. Vanes 14 of Guiding Device 14 split the air flow thereby ensuring more even distribution of the air flow along the perimeter of Chamber 8. Besides that Vanes 14 of additional Guiding Device 13 change the direction of movement of the air flow ensuring its entry into Grinding Chamber 8 in radial direction. The maximum grinding effect is achieved when the machine is equipped with two guiding devices—the main one (11) and additional one (13). The ready-made product is removed from the cavity of Grinding Chamber 8 with the help of Appliance 3 for removal of the final product.

1. The machine for material grinding which includes a frame with appliances for grinding material supply and ready-made product removal respectively, an annular grinding chamber, two rotating rotors installed on a frame in alignment, blades for acceleration of material and its supply to a grinding chamber fixed on one rotor and blades for air delivery into a grinding chamber fixed on the second rotor, is distinguished in that it is equipped with at least one guiding device. At that this guiding device is executed in the form of vanes fixed on a frame and placed inside the grinding chamber. These vanes are disposed evenly around the circle where the center of the circle is located on the longitudinal symmetry axis of the rotors.

2. The machine described in Clause 1 is distinguished by the guiding device which is located at the outlet of the blades for acceleration of material and its supply to a grinding chamber.

3. The machine described in Clause 1 is distinguished by the guiding device being located at the outlet of the blades for air delivery to a grinding chamber.
